(19) United States
(12) Patent Application Publication
(10) Pub. No.: US 2022/0309869 A1
(43) Pub. Date: Sep. 29, 2022

(54) LOCAL CASINO MANAGEMENT SYSTEM WITH OFFLINE ACCESS

(71) Applicant: IGT, Las Vegas, NV (US)

(72) Inventor: Michael FOLIS, Gulfport, MS (US)

(73) Assignee: IGT

(21) Appl. No.: 17/214,328

(22) Filed: Mar. 26, 2021

(51) Int. Cl. G07F 17/32; G06Q 40/00; G06F 40/174; G06F 11/07

(52) U.S. Cl. CPC G07F 17/3234; G06Q 40/125; G06F 40/174; G06F 11/0769

(57) ABSTRACT

A local casino management system includes a processor circuit that receives a first indication that a portion of a network-accessible casino management system is unavailable and, based on the first indication, provides user access to the local casino management system. The local casino management system receives user input indicative of casino transactions, and records transaction data indicative of the casino transactions based on the user input. Based on receipt of a second indication that the network-accessible casino management system is available, the local casino management system transmits the transaction data to the network-accessible casino management system.

### BACKGROUND

Embodiments described herein relate to management systems in a casino environment, and in particular to casino management systems with offline access, such as local casino management systems that maintain certain functionality of network-connected casino management systems while portions of the network-connected casino management systems are unavailable and/or offline.

Many casino operations such as table fills, slot jackpots, cage paperwork, etc. are handled during normal operation using a network-accessible casino management system that records and provides access to transactions across a network. However, portions of the network-accessible casino management system may become unavailable, such as during a scheduled downtime for system upgrade and/or maintenance, or unscheduled downtime based on network or equipment issues. During this period of system unavailability, many casino operations are performed manually using printed forms and paperwork, with many of forms being hand-written on antiquated machines.

### BRIEF SUMMARY

According to some embodiments, a local casino management system includes a processor circuit and a memory comprising machine-readable instructions. When executed by the processor circuit, the instructions cause the processor circuit to receive a first indication that a portion of a network-accessible casino management system is unavailable. The instructions further cause the processor circuit to, based on the first indication, provide user access to the local casino management system. The instructions further cause the processor circuit to receive user input indicative of casino transactions. The instructions further cause the processor circuit to record, by the local casino management system based on the user input, transaction data indicative of the casino transactions. The instructions further cause the processor circuit to receive a second indication that the network-accessible casino management system is available. The instructions further cause the processor circuit to, based on the second indication, transmit the recorded transaction data to the network-accessible casino management system.

According to some embodiments, a casino management device includes a user input device, a processor circuit, and a memory comprising machine-readable instructions. When executed by the processor circuit, the instructions cause the processor circuit to receive a first indication that a portion of the network-accessible casino management system is unavailable. The instructions further cause the processor circuit to, based on the first indication, provide user access to a local casino management system. The instructions further cause the processor circuit to receive, by the user input device, user input indicative of the casino transactions. The instructions further cause the processor circuit to record, by the local casino management system based on the user input, transaction data indicative of the casino transactions. The instructions further cause the processor circuit to receive a second indication that the network-accessible casino management system is available. The instructions further cause the processor circuit to, based on the second indication, transmit the recorded transaction data and an instruction to the network-accessible casino management system to reconcile the transmitted transaction data with previously stored transaction data on the network-accessible casino management system.

According to some embodiments, a casino management method includes receiving, by a casino management device, a first indication that a portion of a network-accessible casino management system is unavailable. The method further includes providing, by the casino management device based on the first indication, user access to a local casino management system. The method further includes receiving, by the casino management device, user input indicative of casino transactions. The method further includes recording, by the local casino management system based on the user input, transaction data indicative of the casino transactions. The method further includes receiving, by the casino management device, a second indication that the network-accessible casino management system is available. The method further includes transmitting the casino transaction data to the network-accessible casino management system. The method further includes storing the transaction data in a local memory of the local casino management system.

### BRIEF DESCRIPTION OF SEVERAL VIEWS OF THE DRAWINGS

FIG. 1 is a schematic block diagram illustrating a network configuration for a network-accessible casino management system, a local casino management system, and a plurality of gaming devices according to some embodiments;

FIG. 2 is a flowchart illustrating operations of systems/methods of facilitating casino management functions using a local casino management system during periods of unavailability of a network-accessible casino management system, according to some embodiments;

FIG. 3 is a diagram of a graphical user interface (GUI) for providing access to the local casino management system for a fill casino management operation, according to some embodiments;

FIG. 4 is a diagram of a GUI for providing access to the local casino management system for a redemption casino management operation, according to some embodiments;

FIG. 5 is a diagram of a GUI for providing access to the local casino management system for a front money casino management operation, according to some embodiments;

FIG. 6 is a diagram of a GUI for providing access to the local casino management system for a withdrawal casino management operation, according to some embodiments;

FIG. 7 is a diagram of a GUI for providing access to the local casino management system for a credit in-trade casino management operation, according to some embodiments;

FIG. 8A is a schematic block diagram illustrating an electronic configuration for a computing device according to some embodiments;

FIG. 8B is a schematic block diagram that illustrates various functional modules of a computing device according to some embodiments; and

FIG. 8C is perspective view of a computing device that can be configured according to some embodiments.

### DETAILED DESCRIPTION

Embodiments described herein relate to management systems in a casino environment, and in particular to casino management systems with offline access, such as local casino management systems that maintain certain functionality of network-connected casino management systems while portions of the network-connected casino management systems are unavailable and/or offline.

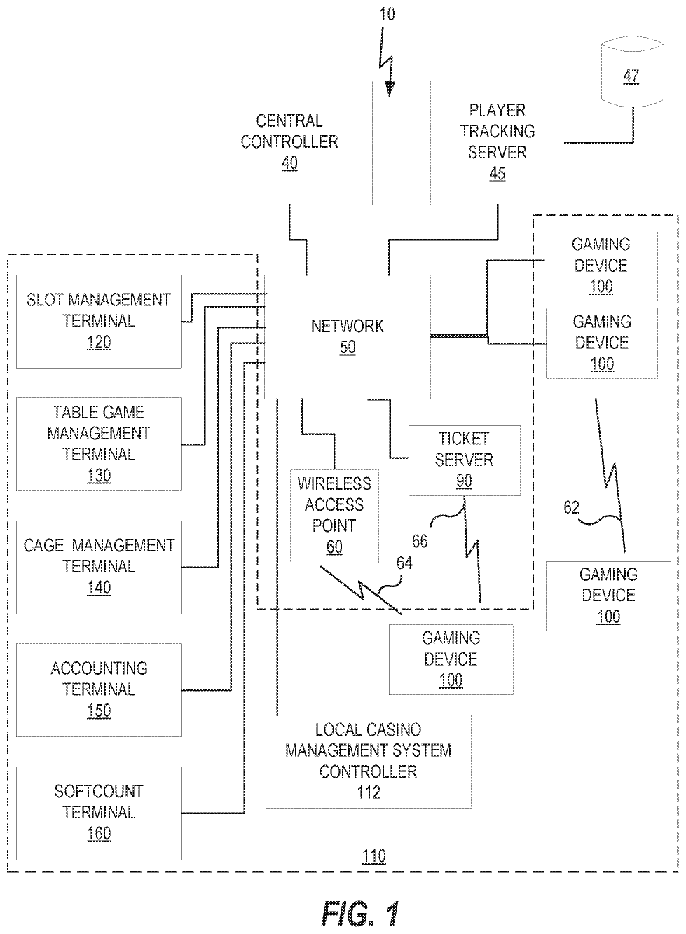

Referring now to FIG. 1, a casino managements system 10 is illustrated. The casino management system 10 may include a plurality of gaming devices 100, such as electronic gaming machines (EGMs), mobile gaming devices, or other devices, for example. The casino management system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processor circuit and at least one memory or storage device.

Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the casino management system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processor circuits as disclosed herein may be performed by the central controller 40.

The gaming devices 100 communicate with one or more elements of the casino management system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

In this embodiment, the casino management system 10 includes a local casino management system 110 that is capable of functioning separately and independently from the network-connected components of the casino management system 10, such as the central controller 40 for example, for certain functions. For example, during periods of unavailability, such as during scheduled downtime, a local casino management system controller 112 can locally manage, record, and store data, such as monetary transaction data, obtained from local casino management system components. These components may include a slot management terminal 120, which tracks and manages slot transactions associated with one or more gaming devices 100, and a table game management terminal, which similarly tracks table game transactions from live and/or electronic table games in the casino. The components may also include a cage management terminal 140, which manages monetary transactions between customers and the casino cage and which also manages fill and credit in transfer transactions between the casino cage and casino personnel, such as table game dealers, etc. The components may include an accounting terminal 150, which manages and reconciles cage transactions with an accounting system, and a softcount terminal 160, which manages and tracks the counting of physical currency, typically located in a secure softcount room. The local casino management system controller 112 in this example transmits and/or reconciles that data with the network-accessible components when those components become available, but it should be understood that different functions described herein can be performed by different individual or groups of computing devices, as desired, to facilitate embodiments disclosed herein.

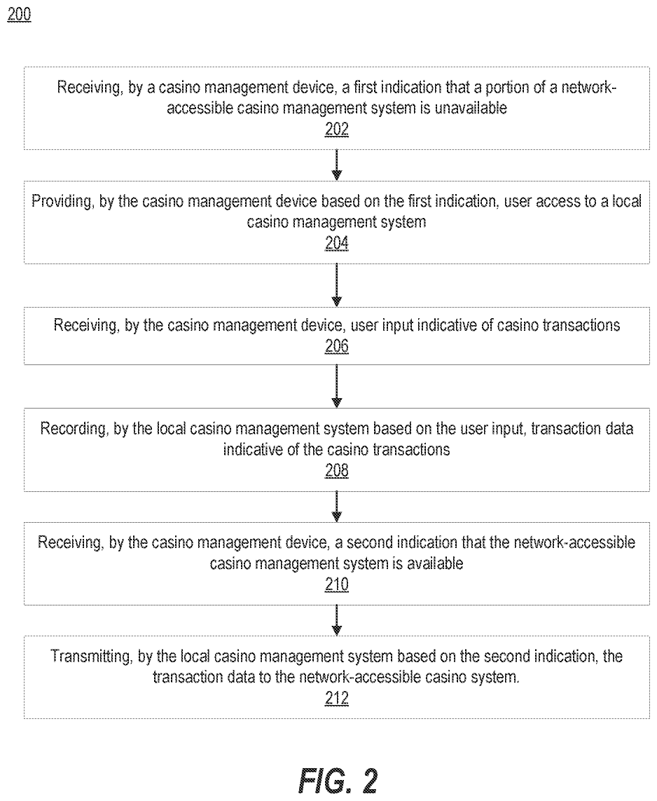

In this regard, FIG. 2 is a flowchart illustrating operations 200 of systems/methods of facilitating casino management functions using a local casino management system, such as the local casino management system 110 of FIG. 1 for example, during periods of unavailability of a network-accessible casino management system, such as the network-connected components of the casino management system 10 of FIG. 1 for example. The operations may include receiving, by a casino management device, a first indication that a portion of a network-accessible casino management system is unavailable (Block 202). In some examples, the casino management device may be part of one or more of the components of the local casino management system 110 of FIG. 1, such as the local casino management controller 112, individual management terminals (e.g., slot management terminal 120, table game management terminal 130, cage management terminal 140, accounting terminal 150, softcount terminal 160, etc.) and/or individual gaming devices 100. As discussed above, different configuration of the network 50 can be used based on a variety of factors, such as security, accessibility, regulatory requirements, or other factors, as desired.

In some embodiments, the first indication may include a message from the network-accessible casino management system that the portion of the network-accessible casino management system is offline. For example, for a scheduled downtime event, the network accessible casino management system (or portion thereof) can transmit a message or otherwise provide an indication that it is offline or otherwise inaccessible. The message can include a future time that the portion of the system will be offline, and may also include a future time that the portion of the system will (or is expected to) no longer unavailable, e.g., online.

In some embodiments, the first indication may include an error message indicative of an inability to access the portion of the network-accessible casino management system. For example, a casino management function may attempt to communicate with the portion of the network-accessible casino management system. If the function is unable to contact or communicate with the portion of the system, the network (e.g., network 50) may indicate that the portion of the system cannot be accessed, e.g., due to a network error, offline status of the portion of the system, inability to securely connect to the portion of the system, or other type of error message.

The operations 200 may further include providing, by the casino management device based on the first indication, user access to a local casino management system (Block 204). In some embodiments, providing access may include automatically launching a graphical interface for the local casino management system at the casino management device based on receipt of the first indication. An indication to a user that the portion of the network-accessible casino management system is unavailable may also be displayed via the graphical interface, or other indication, so that a user is aware that the portion of the network-accessible casino management system is offline.

The operations 200 may further include receiving, by the casino management device, user input indicative of casino transactions (Block 206). In some embodiments, the graphical interface may display a form corresponding to a paper form for recording the casino transactions. For example, rather than manually record casino transaction information on a paper form during system downtime, the local casino management system receives the user input indicative of these transactions during the downtime period.

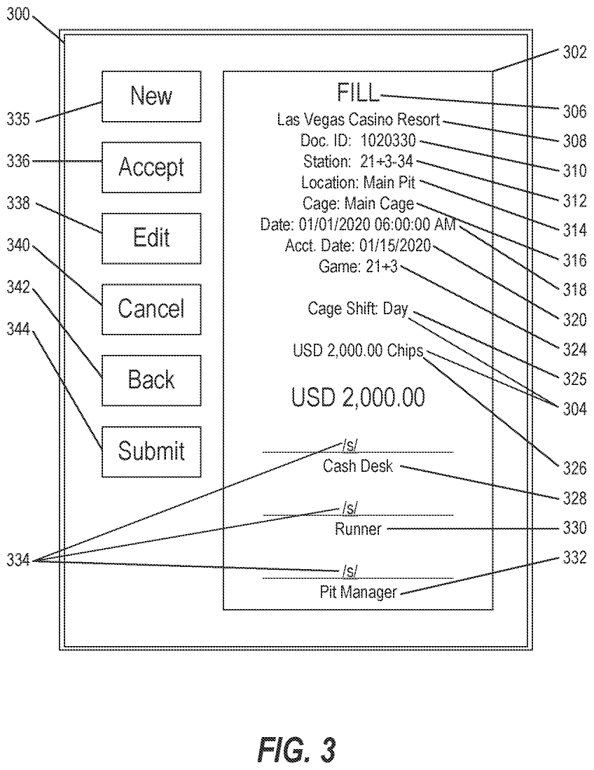

In this regard, FIG. 3 is a diagram of a graphical user interface (GUI) 300 for providing access to the local casino management system for a fill casino management operation, according to some embodiments. A fill operation may include exchanging money (i.e., currency) received by a dealer at a table game for an equivalent value in casino chips.

The GUI 300 includes a graphical form 302 corresponding to a paper fill ticket, with a plurality of data fields 304 that can be manually populated by a user and/or automatically populated by the local casino management system based on data in other fields 304, based on predetermined rules, etc. The graphical form 302 includes an indication of the type of transaction 306 and casino location 308. A unique document ID 310 may be automatically generated for the graphical form 302. Additional location information for the transaction for the fill operation may be manually or automatically populated, such as a station location 312 (e.g., 21+3 Blackjack, table 34 in this example), and general floor location 314 (e.g., main pit), where the fill operation is requested, and a cage location 316 (e.g., main cage) providing the chips for the transaction. A transaction time 318 indicates a time of the transaction, and an accounting time 320 may indicate a time that the transaction is or will be reconciled with the accounting system (which may be offline at the time of the fill operation).

The graphical form 302 may also include additional information, such as a game indication 324 (e.g., 21+3 Blackjack), and a shift indication 325 for the cage (e.g., day shift). In this example, a transaction amount 326 indicates a $2000.000 fill operation, with acknowledgement fields for a cash desk representative 328, who exchanges the cash for chips, a runner 330, who physically delivers the request, chips and currency between the requesting table and the cage, and a pit manager 332, who oversees and verifies the transaction. In this example, the acknowledgement fields 328, 330, 332 may be acknowledged by typing an e-signature 334, but it should be understood that other types of acknowledgements may be used for increased security, efficiency, convenience, and other factors. For example, in some embodiments, the local casino management system 110 may verify an identity of the acknowledging party, such as by reading an identification card, receiving biometric data (e.g., fingerprint data from a fingerprint reader), digitally signing the form via a touchscreen or touchpad/stylus interface, physically signing a printed version of the form, or other operations for verifying a user's identity.

Referring back to FIG. 2, the operations 200 may further include recording, by the local casino management system based on the user input, transaction data indicative of the casino transactions (Block 208). In some embodiments, recording the transaction data may include storing the transaction data in a local memory of the local casino management system. The local memory may be part of the casino management device, or may be accessible via a local network or a portion of the network-accessible casino management system that is currently available.

In this regard, the GUI 300 of FIG. 3 includes a number of graphical commands for creating and managing transaction entries. A new transaction command 335 generates a new graphical form 302 for a new transaction. An accept command 336 accepts and stores the currently entered data in the data fields 304. An edit command 338 allows entry of new or different data into data fields 304 of a stored graphical form 302. A cancel command 340 discards data entered into the data fields 304 that has not been accepted. A back command 342 exits this portion of the GUI 500, e.g., to access a main menu or other portion of the GUI 500. A submit command 344 causes stored data to be submitted for reconciliation with the network-accessible casino management system.

Referring back to FIG. 2, the operations 200 may further include receiving, by the casino management device, a second indication that the network-accessible casino management system is available (Block 210). As with the first indication described above, the indication may be provided by the network-accessible casino management system (or portion thereof), e.g., as a message indicating that it is back online and accessible, for example at the scheduled end time for the scheduled downtime event example above. In some embodiments, the second indication may include a message indicative of an online status for the previously unavailable portion of the network-accessible casino management system. For example, a casino management function may periodically attempt to communicate with the portion of the network-accessible casino management system. Once the function is able to successfully contact or communicate with the previously offline portion of the system, the network (e.g., network 50) may indicate that the portion of the system can now be accessed.

The operations 200 may further include transmitting, by the local casino management system based on the second indication, the transaction data to the network-accessible casino system (Block 212). Transmitting the retrieved transaction data can also include an instruction to the network-accessible casino management system to reconcile the transmitted transaction data with previously stored transaction data on the network-accessible casino management system. For example, the retrieved transaction data can be transmitted in a format that matches or can be converted to data that can be input into the portion of the network accessible casino management system so that all of the relevant transaction data for the downtime period is appropriately recorded. One advantage of this and other embodiments is that, rather than manually transcribing and inputting data from paper forms, the relevant transaction data can be input and recorded contemporaneously, and automatically reconciled with the network-accessible casino management system, thereby reducing the chances of transcription errors, lost records, and other issues that arise with conventional paper-form based techniques for recording transactions during periods of downtime.

In some examples, the local casino management system may generate a report indicative of the casino transactions. The report may include retrieving the stored transaction data from the local memory of the local casino management system. The retrieved data can be used by the local casino management system to populate the report with the casino transactions based on the retrieved transaction data. A copy of the paper form containing the recorded casino transactions can in turn be printed or otherwise generated, and/or the data can be otherwise displayed, stored, and/or electronically shared. In some examples, the retrieved transaction data can be transmitted to the now-online network-accessible casino management system.

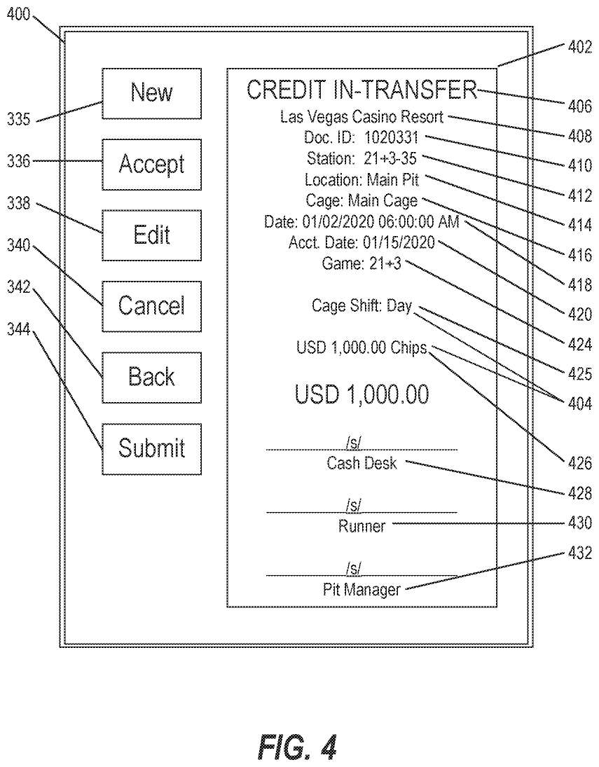

Additional examples of functions that can be facilitated by a local casino management system according to some embodiments are described below with respect to FIGS. 4-7. In this regard, FIG. 4 is a diagram of a GUI 400 providing access to the local casino management system for a credit in-transfer casino management operation, according to some embodiments. A credit in-transfer operation may include delivering money received by a dealer at a table game to the casino cage.

The GUI 400 includes a graphical form 402 corresponding to a paper credit in-transfer ticket, with a plurality of data fields 404 that can be manually and/or automatically populated. The graphical form 402 includes an indication of the type of transaction 406 and casino location 408. A unique document ID 410 may be automatically generated for the graphical form 402. Additional location information for the transaction for the fill operation may be manually or automatically populated, such as a station location 412, general floor location 414, and cage location 416. A transaction time 418 and an accounting time 420 may be manually or automatically populated. In this example, additional information includes a game indication 424 and shift indication 425. A transaction amount 426 indicates a $1000.000 credit in-transfer operation, with acknowledgement fields for a cash desk representative 428, who receives the transferred currency, a runner 430, who physically delivers currency from the table to the cage, and a pit manager 432, who oversees and verifies the transaction.

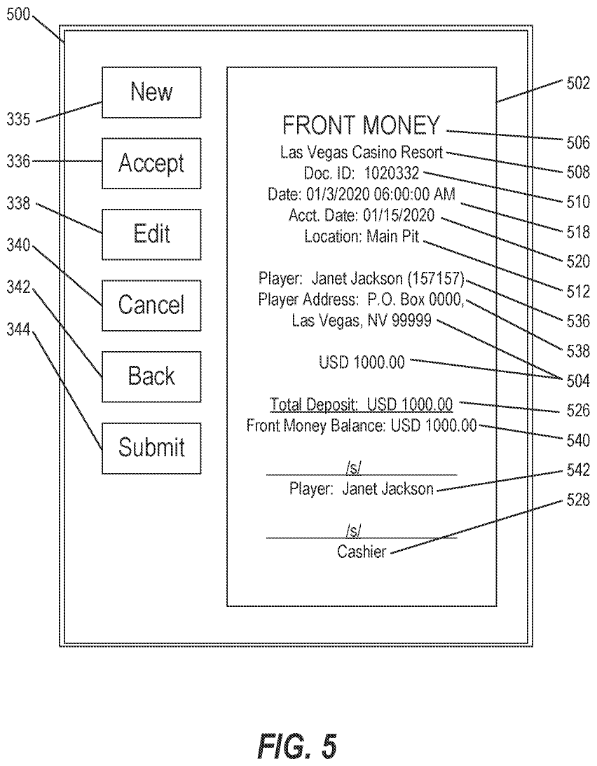

FIG. 5 is a diagram of a GUI 500 for providing access to the local casino management system for a front money deposit casino management operation, according to some embodiments. A front money deposit may include a player or other customer depositing personal funds into a personal account with the casino to be used as casino credit.

The GUI 500 includes a graphical form 502 corresponding to a front money deposit ticket, with a plurality of data fields 504 that can be manually and/or automatically populated. The graphical form 502 in this example includes an indication of the type of transaction 506, casino location 508, and a unique document ID 510 may be automatically generated for the graphical form 502. Location information 512, a transaction time 518 and an accounting time 520 may be manually and/or automatically populated. In this example, additional information includes an indication of a name 536 and address 538 for a player associated with the front money deposit account. A transaction amount 526 indicates a $1000.000 front money deposit operation, and an indication of a total available front money balance 540 (also $1000.00), with acknowledgement fields for the player 542 making the deposit and a cashier 528 receiving and processing the deposit.

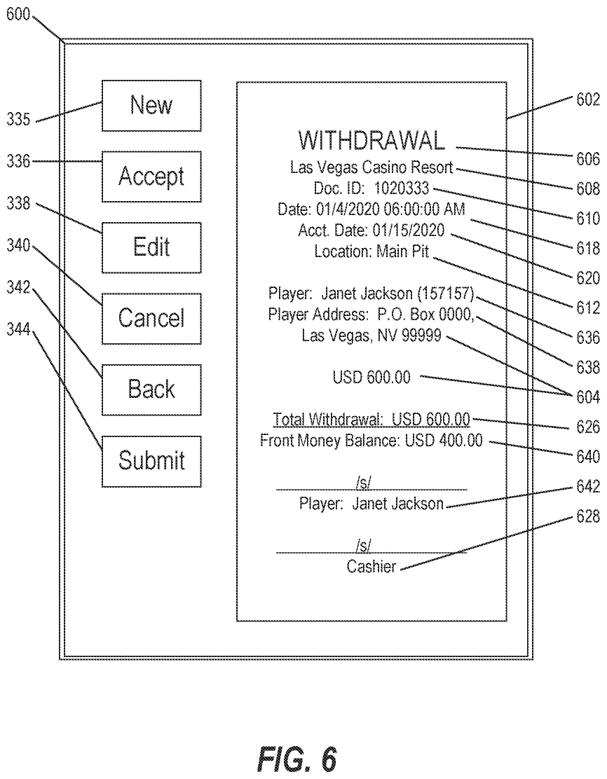

FIG. 6 is a diagram of a GUI 600 for providing access to the local casino management system for a front money withdrawal casino management operation, according to some embodiments. Similar to a front money deposit (described above), a front money withdrawal may include a player or other customer withdrawing previously deposited funds from the player's personal account with the casino. Similar to the graphical form 502 of FIG. 5, the graphical form 602 in this example includes an indication of the type of transaction 606, unique document ID 610, location information 612, a transaction time 618 and an accounting time 620, and name 636 and address 638 for the player making the withdrawal. A transaction amount 626 indicates a $600.000 front money withdrawal operation, and an indication of a total available remaining front money balance 640 (now $400.00), with acknowledgement fields for the player 642 making the withdrawal and a cashier 628 processing the withdrawal and providing the currency to the player.

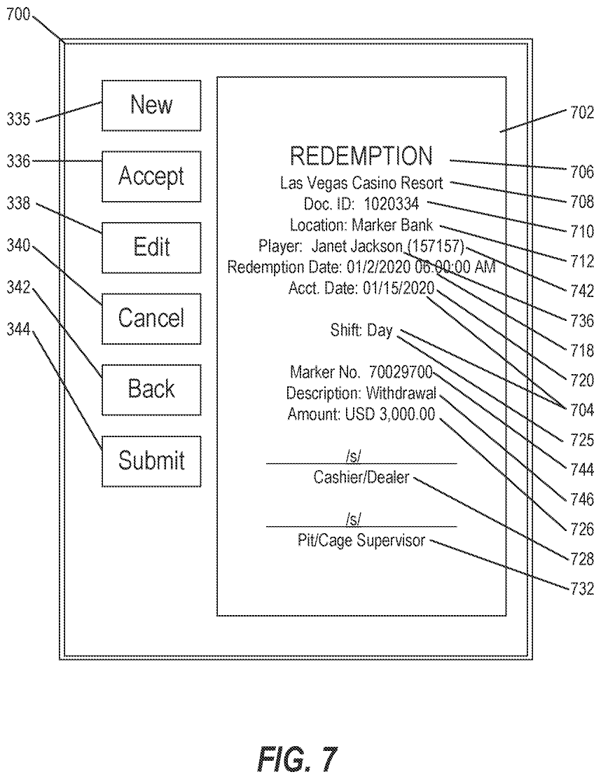

FIG. 7 is a diagram of a GUI 700 for providing access to the local casino management system for a redemption casino management operation, according to some embodiments. For example, a redemption may include a player or other customer redeeming a marker (i.e., loan from the casino to the player). In this example, a graphical form 702 includes an indication of the type of transaction 706, casino location 708, and unique document ID 710, location information 712, player name 736 and player ID 742, a transaction time 718 an accounting time 720, a shift indication 725. The graphical form 702 in this example also includes a marker ID 744 and description of the transaction (i.e., withdrawal) 746 and amount of the transaction 726 (i.e., $3,000.00 withdrawal) associated with the marker, with acknowledgement fields for the cashier and/or dealer 728 processing the redemption and a pit manager 732, who oversees and verifies the transaction.

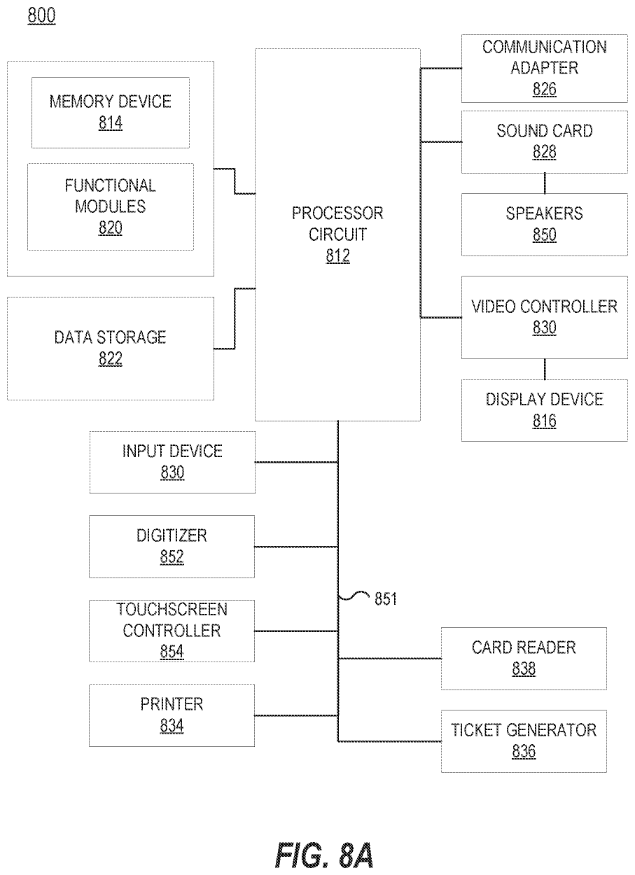

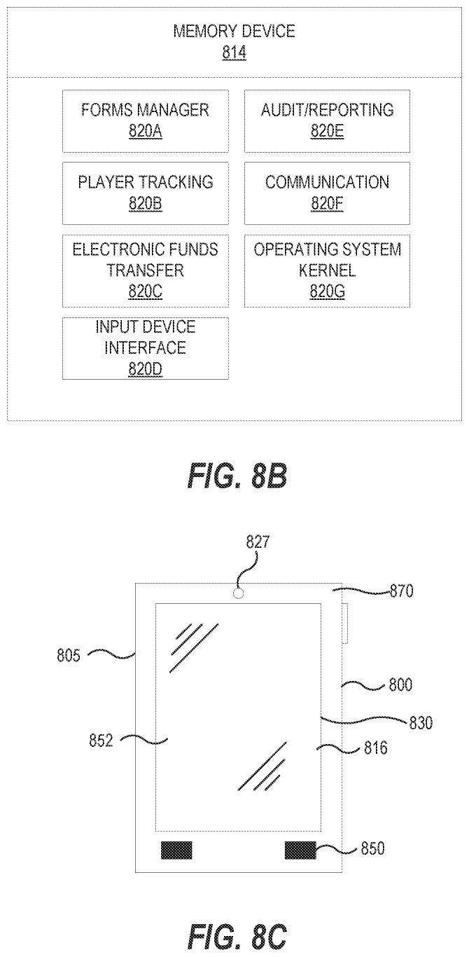

Embodiments herein may include many other types of transactions as well, and may employ different types of computing devices for different types of transactions. One example of a computing device 800, such as the local casino management controller 112 for example, is illustrated in FIGS. 8A and 8B. FIG. 8A is a functional block diagram that schematically illustrates an electronic relationship of various elements of the computing device 800, and FIG. 8B illustrates various functional modules that can be stored in a memory device of the computing device 800. The embodiments shown in FIGS. 8A-8B are provided as examples for illustrative purposes only. It will be appreciated that computing devices may come in many different shapes, sizes, layouts, form factors, and configurations, and with varying numbers and types of input and output devices, and that embodiments are not limited to the particular computing device structures described herein.

FIG. 8A is a block diagram that illustrates logical and functional relationships between various components of a computing device 800 suitable for use with embodiments described herein, such as the local casino management controller 112, terminals 120, 130, 140, 150, 160, and/or other components. It should also be understood that components described in FIG. 8A may also be used in other computing devices, as desired, such as mobile computing devices for example. As shown in FIG. 8B, the computing device 800 may include a processor circuit 12 that controls operations of the computing device 800. Although illustrated as a single processor circuit, multiple special purpose and/or general-purpose processors and/or processor cores may be provided in the computing device 800. For example, the computing device 800 may include one or more of a video processor, a signal processor, a sound processor and/or a communication controller that performs one or more control functions within the computing device 800. The processor circuit 12 may be variously referred to as a “controller,” “microcontroller,” “microprocessor” or simply a “computer.” The processor may further include one or more application-specific integrated circuits (ASICs).

Various components of the computing device 800 are illustrated in FIG. 8A as being connected to the processor circuit 812. It will be appreciated that the components may be connected to the processor circuit 812 through a system bus 851, a communication bus and controller, such as a universal serial bus (USB) controller and USB bus, a network interface, or any other suitable type of connection.

The computing device 800 further includes a memory device 814 that stores one or more functional modules 820. Various functional modules 820 of the computing device 800 will be described in more detail below in connection with FIG. 8B.

The memory device 814 may store program code and instructions, executable by the processor circuit 812, to control the computing device 800. The memory device 814 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 814 may include read only memory (ROM). In some embodiments, the memory device 814 may include flash memory and/or EEPROM (electrically erasable programmable read only memory). Any other suitable magnetic, optical and/or semiconductor memory may operate in conjunction with the gaming device disclosed herein.

The computing device 800 may further include a data storage 822, such as a hard disk drive or flash memory. The data storage 822 may store program data, player data, audit trail data or any other type of data. The data storage 822 may include a detachable or removable memory device, including, but not limited to, a suitable cartridge, disk, CD ROM, Digital Video Disc (“DVD”) or USB memory device.

The computing device 800 may include a communication adapter 826 that enables the computing device 800 to communicate with remote devices over a wired and/or wireless communication network, such as a local area network (LAN), wide area network (WAN), cellular communication network, or other data communication network. The communication adapter 826 may further include circuitry for supporting short range wireless communication protocols, such as Bluetooth and/or NFC that enable the computing device 800 to communicate, for example, with a mobile communication device operated by a player.

The computing device 800 may include one or more internal or external communication ports that enable the processor circuit 812 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processor circuit through a USB hub (not shown) connected to the processor circuit 812.

The computing device 800 may include a number of input devices 830 that allow a user to provide various inputs to the computing device 800. In some embodiments, as shown in FIG. 8A, the input device(s) 830 may include and/or interact with additional components, such as a touch-sensitive display that includes a digitizer 852 and a touchscreen controller 854 for touch input devices, as disclosed herein. The player may interact with the computing device 800 by touching virtual buttons on one or more display devices 816. Accordingly, any of the above-described input devices 830 may be provided as virtual buttons or regions on the display device 816. Operation of the display device 816 may be controlled by a video controller 832 that receives video data from a processor circuit 12 or directly from a memory device 814 and displays the video data on the display screen.

The display device 816 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device 816 may include a touchscreen with an associated touchscreen controller 854 and digitizer 852. The display device 816 may be of any suitable size, shape, and/or configuration.

The display device 816 and video controller 832 of the computing device 800 are generally configured to display a GUI, such as the GUIs 300, 400, 500, 600, 700 described above with respect to FIGS. 3-7, for example. The computing device 800 may further include one or more speakers 850 controlled by one or more sound cards 828.

The computing device 800 also includes various features that enable a user to output data to a physical and/or portable format. For example, the computing device 800 may include a printer 834, and/or a ticket generator 836, for providing printed records of recorded transactions, for example.

The gaming device 800 may further include a card reader 838 that is configured to read magnetic stripe cards, smart cards having a programmed microchip, or the like, such as user identification cards for providing access to the computing device 800. In other embodiments, a user may carry a portable device, such as a cell phone, a radio frequency identification tag or any other suitable wireless device, which communicates a user's identification and other relevant information to the computing device 800.

Various functional modules of that may be stored in a memory device 814 of a computing device 800 are illustrated in FIG. 8B. Referring to FIG. 8B, the computing device 800 may include in the memory device 814 a forms manager module 820A that includes program instructions and/or data for performing operations of the local casino management system 110 as described herein. The computing device 800 may further include additional functionality, such as a player tracking module 820B, an electronic funds transfer module 820C, an input device interface 820D, an audit/reporting module 820E, a communication module 820F, and/or an operating system kernel 820G, as desired. The player tracking module 820B keeps track of the play and other transactions associated with a player. The electronic funds transfer module 820C communicates with a back-end server or financial institution to transfer funds to and from various financial accounts. The input device interface 820D interacts with input devices, such as the input device 830 described above. The communication module 820F enables the computing device 800 to communicate with remote servers and other components of the casino management system 10 using various secure communication interfaces. The operating system kernel 820G controls the overall operation of the computing device 800, including the loading and operation of other modules.

In some embodiments, a computing device 800 includes a personal device, such as a desktop computer, a laptop computer, a mobile device, a tablet computer or computing device, a personal digital assistant (PDA), or other portable computing devices. In some embodiments, the computing device 800 may be operable over a wireless network, such as part of a wireless casino management system. In such embodiments, the computing device 800 may be a hand-held device, a mobile device or any other suitable wireless device that enables a user to access the casino management system 10 a variety of different locations. It should be appreciated that a computing device 800 as disclosed herein may be a device that has obtained approval from a regulatory body, such as a gaming commission or financial oversight organization, or a device that has not obtained approval from a regulatory body.

For example, referring to FIG. 8C, a computing device 800 (which is a mobile computing device 870 in this embodiment) may be implemented as a handheld device including a compact housing 805 on which is mounted a touchscreen display device 816 including a digitizer 852. One or more input devices 830 may be included for providing functionality of embodiments described herein. A camera 827 may be provided in a front face of the housing 805. The housing 805 may include one or more speakers 850. In the computing device 800, various input buttons described above may be implemented as soft buttons on the touchscreen display device 816 and/or input device 830. In this embodiment, the input device 830 is integrated into the touchscreen display device 816, but it should be understood that the input device 830 may also, or alternatively, be separate from the display device 816.

Although illustrated as certain computing devices, such as standalone computing devices and mobile computing devices, functions and/or operations as described herein may also include components of gaming devices, such as electronic game tables, conventional game tables including those involving cards, dice and/or roulette, and/or other wagering stations such as sports book stations, video poker games, skill-based games, virtual casino-style table games, or other casino or non-casino style games. Further, computing devices according to embodiments herein may be implemented using other types of devices, such as smart phones, tablets, and/or personal computers, among others.

Embodiments described herein may be implemented in various configurations for computing device 800, including but not limited to: (1) a dedicated computing device, wherein the computerized instructions for controlling the device are stored by the computing device; and (2) a changeable computing device, where the computerized instructions for controlling the device are downloadable to the computing device through a data network. In some embodiments, the computerized instructions for controlling functions disclosed herein are executed by at least one local or network-connected server, central controller or remote host. In such a “thin client” embodiment, the central server remotely controls certain functions, and the computing device is utilized to display such functionality (or suitable interfaces) and receive one or more inputs or commands from a user. In another embodiment, the computerized instructions are communicated from the local or network-connected server, central controller or remote host to a computing device local processor and memory devices. In such a “thick client” embodiment, the computing device local processor executes the communicated computerized instructions to control such functionality (or other suitable interfaces) provided to a user.

In some embodiments, a computing device may be operated by a mobile device, such as a mobile telephone, tablet other mobile computing device. For example, a mobile device may be communicatively coupled to a computing device and may include a user interface that receives user inputs that are received to control the computing device. The user inputs may be received by the computing device via the mobile device.

In some embodiments, one or more computing devices in a casino management system may be thin client computing devices and one or more computing devices in the casino management system may be thick client computing devices. In another embodiment, certain functions of the computing device are implemented in a thin client environment and certain other functions of the computing device are implemented in a thick client environment.

The present disclosure contemplates a variety of different casino management systems each having one or more of a plurality of different features, attributes, or characteristics. It should be appreciated that a “casino management system” as used herein refers to various configurations of: (a) one or more central servers, central controllers, or remote hosts; (b) one or more computing devices; and/or (c) one or more personal computing devices, such as desktop computers, laptop computers, tablet computers or other computing devices, PDAs, mobile telephones such as smart phones, and other mobile computing devices.

In certain such embodiments, computerized instructions for controlling any functionality are executed by the central server, central controller, or remote host. In such “thin client” embodiments, the central server, central controller, or remote host remotely controls any functionality displayed by the computing device, and the computing device is utilized to display such functionality and to receive one or more inputs or commands. In other such embodiments, computerized instructions for controlling any functionality of the computing device are communicated from the central server, central controller, or remote host to the computing device and are stored in at least one memory device of the computing device. In such “thick client” embodiments, the at least one processor of the computing device executes the computerized instructions to control such functionality displayed by the computing device.

In some embodiments in which the computing system includes: (a) a computing device configured to communicate with a central server, central controller, or remote host through a data network; and/or (b) a plurality of computing devices configured to communicate with one another through a data network, the data network is an internet or an intranet. In certain such embodiments, an internet browser of the computing device is usable to access an internet page from any location where an internet connection is available. In one such embodiment, after the internet game page is accessed, the central server, central controller, or remote host identifies a user prior to enabling that user to access certain functionality. In one example, the central server, central controller, or remote host identifies the user by requiring a user account of the user to be logged into via an input of a unique username and password combination assigned to the user. It should be appreciated, however, that the central server, central controller, or remote host may identify the user in any other suitable manner, such as by validating a user tracking identification number associated with the user; by reading a user tracking card or other smart card inserted into a card reader; by validating a unique user identification number associated with the user by the central server, central controller, or remote host; or by identifying the computing device, such as by identifying the MAC address or the IP address of the internet facilitator. In various embodiments, once the central server, central controller, or remote host identifies the user, the central server, central controller, or remote host enables and displays certain functionality via the internet browser of the computing device.

It should be appreciated that the central server, central controller, or remote host and the computing device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random-access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor circuit of a general-purpose computer, special purpose computer, or other programmable data processing apparatus to produce a machine, such that the instructions, which execute via the processor circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A local casino management system comprising:
a processor circuit; and
a memory comprising machine-readable instructions that, when executed by the processor circuit, cause the processor circuit to:
receive a first indication that a portion of a network-accessible casino management system is unavailable;
based on the first indication, provide user access to the local casino management system;
receive user input indicative of casino transactions;
record, by the local casino management system based on the user input, transaction data indicative of the casino transactions;
receive a second indication that the network-accessible casino management system is available; and
based on the second indication, transmit the recorded transaction data to the network-accessible casino management system.

2. The system of claim 1, wherein the first indication comprises a message from the network-accessible casino management system that the portion of the network-accessible casino management system is offline.

3. The system of claim 1, wherein the first indication comprises an error message indicative of an inability to access the portion of the network-accessible casino management system.

4. The system of claim 1, wherein the instructions that cause the processor circuit to provide user access to the local casino management system further cause the processor circuit to automatically launch a graphical interface based on receipt of the first indication.

5. The system of claim 4, wherein the instructions further cause the processor circuit to provide an indication to a user that the portion of the network-accessible casino management system is unavailable.

6. The system of claim 1, wherein the instructions that cause the processor circuit to provide user access to the local casino management system further cause the processor circuit to display a form corresponding to a paper form for recording the casino transactions.

7. The system of claim 6, wherein the instructions that cause the processor circuit to record the transaction data further cause the processor circuit to store the transaction data in a local memory of the local casino management system.

8. The system of claim 7, wherein the instructions that cause the processor circuit to transmit the transaction data further cause the processor circuit to:
retrieve the stored transaction data from the local memory of the local casino management system; and
transmit the retrieved transaction data to the network-accessible casino management system.

9. The system of claim 8, wherein the instructions further cause the processor circuit to transmit an instruction to the network-accessible casino management system to reconcile the transmitted transaction data with previously stored transaction data on the network-accessible casino management system.

10. The system of claim 7, wherein the instructions further cause the processor circuit to:
retrieve the stored transaction data from the local memory of the local casino management system; and
generate a report indicative of the casino transactions.

11. The system of claim 1, wherein the second indication comprises a message from the network-accessible casino management system that the portion of the network-accessible casino management system is online.

12. The system of claim 1, wherein the second indication comprises a network access message indicative of an availability to access the portion of the network-accessible casino management system.

13. A casino management device comprising:
a user input device;
a processor circuit; and
a memory comprising machine-readable instructions that, when executed by the processor circuit, cause the processor circuit to:
access a network-accessible casino management system is unavailable to record data indicative of casino transactions;
receive a first indication that a portion of the network-accessible casino management system is unavailable;
based on the first indication, provide user access to a local casino management system;
receive, by the user input device, user input indicative of the casino transactions;
record, by the local casino management system based on the user input, transaction data indicative of the casino transactions;
receive a second indication that the network-accessible casino management system is available; and
based on the second indication, transmit the recorded transaction data and an instruction to the network-accessible casino management system to reconcile the transmitted transaction data with previously stored transaction data on the network-accessible casino management system.

14. The device of claim 13, further comprising a display device, wherein the instructions that cause the processor circuit to provide user access to the local casino management system further cause the processor circuit to automatically launch a graphical interface on the display device based on receipt of the first indication.

15. The device of claim 13, wherein the instructions that cause the processor circuit to provide user access to the local casino management system further cause the processor circuit to display a form corresponding to a paper form for recording the casino transactions, and
wherein the instructions that cause the processor circuit to record the transaction data further cause the processor circuit to store the transaction data in the memory.

16. The device of claim 15, wherein the instructions that cause the processor circuit to transmit the transaction data further cause the processor circuit to:
retrieve the stored transaction data from the memory;
transmit the retrieved transaction data and the instruction to the network-accessible casino management system.

17. A casino management method comprising:
receiving, by a casino management device, a first indication that a portion of a network-accessible casino management system is unavailable;
providing, by the casino management device based on the first indication, user access to a local casino management system;
receiving, by the casino management device, user input indicative of casino transactions;
recording, by the local casino management system based on the user input, transaction data indicative of the casino transactions;
receiving, by the casino management device, a second indication that the network-accessible casino management system is available;
transmitting the casino transaction data to the network-accessible casino management system; and
storing the transaction data in a local memory of the local casino management system.

18. The method of claim 17, further comprising automatically launching, by the casino management device, a graphical interface for the local casino management system based on receipt of the first indication.

19. The method of claim 17, further comprising displaying, by the casino management device, a form corresponding to a paper form for recording the casino transactions, and
printing a copy of the paper form containing the recorded casino transactions.

20. The method of claim 17, further comprising:
transmitting an instruction to the network-accessible casino management system to reconcile the transmitted transaction data with previously stored transaction data on the network-accessible casino management system.
